(19) United States
(12) Patent Application Publication
(10) Pub. No.: US 2003/0123521 A1
(43) Pub. Date: Jul. 3, 2003

(54) Operating a light emitting diode

(75) Inventor: Jukka Luoma, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/300,693

(22) Filed: Nov. 19, 2002

(30) Foreign Application Priority Data
Nov. 19, 2001 (EP) EP01127555.9

(51) Int. Cl. G01K 7/00

(52) U.S. Cl. 374/183

(57) ABSTRACT

The invention relates to a method for operating a light emitting diode (LED). In order to enable an influence on the lifetime of the LED, it is proposed that the method comprises measuring the ambient temperature surrounding the LED, and controlling a current through the LED depending on the measured temperature. The invention equally relates to a corresponding device comprising at least one LED 1. It is proposed that this devices further comprises a temperature sensing element 2 for measuring the ambient temperature surrounding the at least one LED 1, and controlling means 3 for controlling a current flowing through said at least one LED 1 depending on the measured temperature.

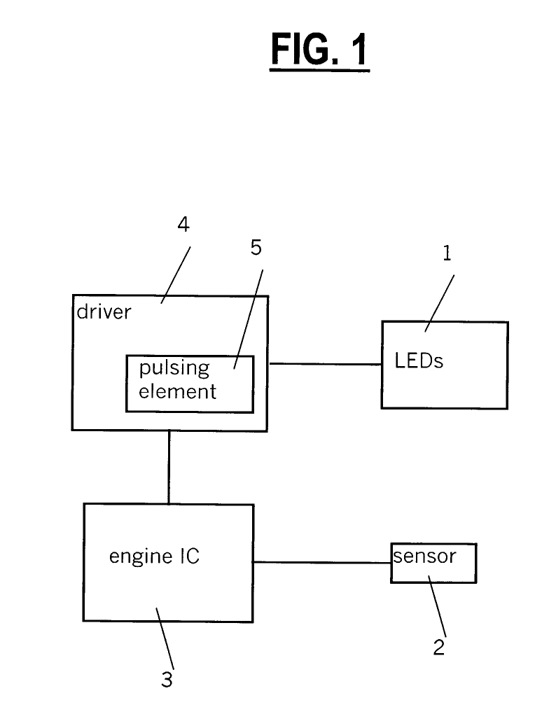

### CROSS REFERENCE TO RELATED APPLICATIONS

This application claims priority under 35 USC §119(e) to European Patent Application No. 01 127 555.9 filed on Nov. 19, 2001.

### FIELD OF THE INVENTION

The invention relates to a method for operating a light emitting diode (LED). The invention equally relates to a device comprising at least one LED.

### BACKGROUND OF THE INVENTION

The use of LEDs is well known in the art. LEDs are also employed in a great variety of applications, for example in a display or a keypad lighting of a user interface hardware.

The intensity of the light emitted by an LED correlates with the level of a supplied current. Additionally, however, the luminous intensity of LEDs is subject to a degradation over time. The degradation rate and therefore the useful lifetime of an LED depends on the power over the LED. The power over the LED, in turn, depends on the forward current supplied to the LED and on the ambient temperature surrounding the LED. Thus, on the one hand, the luminous intensity of an LED supplied with a high current can degrade relatively fast. On the other hand, the luminous intensity of an LED can degrade rather quickly in case of a high ambient temperature, in particular in case of an ambient temperature which is higher than a maximum temperature specified in the respective LED specification.

A correlation between the power over LEDs and the temperature surrounding these LEDs has also been addressed in the document JP 2001043728, which aims at avoiding fluctuations in the light quality due to changes in temperature. In this document, a light emitting diode lighting system is described, in which a plurality of LEDs is arranged on a heat radiating plate. The LEDs emit light due to current pulses supplied by an LED driver. In order to avoid fluctuations in the light quality, it is proposed that the temperature of the heat radiating plate is regulated by thermo modules absorbing heat on the heat radiating plate.

Suppressing a rise in the ambient temperature would also be suited for increasing the lifetime of an LED. In many cases, however, for example in mobile phones, it is not possible to ensure that the ambient temperature does not exceed a maximum value that is allowed for the LED with the employed forward current.

In known applications, the problem is either ignored, or several LEDs with a low current are employed instead of one LED with a high current, in order to reduce the power over the single LEDs.

### SUMMARY OF THE INVENTION

It is an object of the invention to enable an influence on the lifetime of an LED. It is in particular an object of the invention to provide a possibility for preventing a rapid aging of an LED that may be exposed to high ambient temperatures, and more specifically for preventing a fast degradation of the luminous intensity of such an LED.

These objects are reached on the one hand with a method for operating an LED. It is proposed for such a method that in a first step the ambient temperature surrounding the LED is measured. It is further proposed that in a second step, a current through the LED is controlled depending on the measured temperature.

On the other hand, the objects are reached with a device comprising at least one LED. It is proposed that the device further comprises a temperature sensing element for measuring the ambient temperature surrounding the at least one LED, and controlling means for controlling a current flowing through the at least one LED depending on the measured temperature.

The invention proceeds from the idea that the luminous intensity and thus the lifetime of an LED depend in particular on the respective combination of the current through the LED and the ambient temperature. More specifically, a high ambient temperature has less influence on the lifetime of an LED in case a low current is supplied to the LED, and vice versa. Therefore, the lifetime of an LED can be influenced by varying the current through the LED depending on a measured temperature surrounding the LED.

It is proposed in particular that the average current is decreased with rising ambient temperatures and increased with falling ambient temperatures, in order to increasing the lifetime of an LED.

It is an advantage of the invention that the full luminous intensity of an LED can be made available for a longer time, while at the same time an optimal output depending on the present temperature situation can be guaranteed.

Further, there is a lower risk that an LED deteriorates so much that a repair becomes necessary. As a result, also the satisfaction of the user is increased.

In comparison to a solution using for each required LED several LEDs with a lower current in order to reduce the degradation of the luminance intensity, the invention moreover requires less LEDs. Thus, the mechanical size and the costs of the device can be reduced. In addition, the power consumption will be lower, since one LED supplied with a high current requires less power than several LEDs supplied with a corresponding lower current.

Preferred embodiments of the invention become apparent from the subclaims.

There are several possibilities for controlling the current through an LED.

In a first alternative, the current is controlled analogously, i.e. the forward current is changed linearly or in several steps as a function of the measured temperature. Such a direct current control has the disadvantage that in some cases a change of the forward current may result in a change of the LED color.

In a second, preferred alternative, which avoids the problem of changing colors, the current is controlled digitally. In this alternative, the LED forward current is kept constant, but the current is pulsed, i.e. it is turned on and off e.g. over a hundred times per second. The average current is then adapted to the measured temperature by changing the duty ratio of the pulsing. The duty ratio determines the ratio between the time in which a current is provided, i.e. the total length of the pulses, and the time in which a current is not provided, i.e. the total length between the pulses.

For the human eye, the duty ratio of the pulsing determines the average current and therefore the luminous intensity. With a 50% duty ratio for instance, the LED average current will be 50% of the value without any pulsing. Therefore, the luminous intensity is the same as with a constant current reduced to 50%. The luminous intensity follows the current almost linearly at a given ambient temperature.

The pulsing can be realized in several ways. It can moreover be achieved by measures on the anode side of the LED, at which the current is provided, or by measures on the cathode side of an LED.

On the cathode side of an LED, switching means like a transistor, e.g. a FET (field effect transistor), can be employed for realizing the pulsing. For turning the LED on, the switching means can connect the cathode of the LED to ground, and for turning the LED off, the switching means can connect the LED to a high voltage. The high voltage should be as close as possible to LED supply voltage, in order to avoid that any current passes the LED.

On the anode side of an LED, the LED can be turned on and off by a pulsing element controlling the power supply to the LED.

To this end, a power supply circuit or some other driver providing power to the LED can be pulsed between shut down and enable states by a pulsing element, e.g. by an active current control. Several LEDs in series may also be supplied with a pulsed current this way.

The pulsing element can be controlled for example by an engine IC. Engine ICs are employed e.g. in mobile phones for data processing. The pulsing element can even be integrated into such an engine IC. Alternatively the pulsing element can be controlled by an LED driver or be integrated into an LED driver.

The ambient temperature surrounding an LED can be measured according to the invention with a temperature-sensing element. The temperature sensing element can be arranged at any suitable place in, on or close to a device comprising at least one LED that is to be operated. The temperature-sensing element can also be integrated into some other unit of the device, like an engine IC or an LED driver.

If an engine IC is present in a device with the at least one LED that is to be operated, the measurement results of a temperature sensing element may be evaluated by a software of the engine IC for controlling a pulsing element employed for supplying a pulsed current to the LED.

Alternatively, an LED driver or any other processing unit in a device with the at least one LED that is to be operated can evaluate the temperature information from the temperature sensing element. In this case, an engine IC does not need to control the LED current, or sense the temperature.

### BRIEF DESCRIPTION OF THE FIGURE

In the following, the invention is explained in more detail with reference to a drawing. The only FIGURE shows a simplified block diagram of an exemplary embodiment of a device according to the invention.

### DETAILED DESCRIPTION OF THE INVENTION

The only FIGURE shows a block diagram with selected elements of an embodiment of a device according to the invention comprising an LED arrangement 1. The device can be for instance a mobile phone, in which the LED arrangement is employed for the display.

In the device, a temperature sensor 2 is arranged close to the LED arrangement 1. The output of the temperature sensor 2 is connected to an input of a phone engine IC 3. The output of the engine IC 3 is connected to an input of an LED driver 4. The LED driver 4 comprises a pulsing element 5, and is further connected to the LED arrangement 1.

For operating the LED arrangement 1 with an appropriate current, the ambient temperature surrounding the LED arrangement is detected with the temperature sensor 2. The measurement results of the temperature sensor 2 are read by the engine IC 3 of the mobile phone.

The engine IC 3 comprises a software for processing the received measurement results. This software determines the current ambient temperature out of the received measurement results. Based on the determined temperature, the software then calculates a duty ratio for pulsing a current that is to be supplied to the LED arrangement. The ratio is calculated such that it is lower the higher the temperature is determined. The calculated duty ratio is then forwarded to the LED driver 4.

The LED driver 4 is responsible for supplying the LED arrangement 1 with a current adapted to the ambient temperature. To this end, the pulsing element integrated in the LED driver 4 is able to pulse an available current with a variable duty ratio, which variable duty ratio is set to the duty ratio provided by the engine IC 3. The LED driver 4 supplies the pulsed current to the LED arrangement 1. The higher the duty ratio provided by the engine IC 3, the larger the portion of time during which pulses of the same amplitude are supplied within one second to the LED arrangement 1.

Thus, the LED arrangement 1 is supplied with a current of which a short-term average is inversely proportional to the ambient temperature surrounding the LED arrangement 1. As a consequence, a rapid degradation of the luminous intensity provided by the LED arrangement 1 is prevented.

It is to be noted that the proposed embodiment of a device and of a method according the invention can be amended in any suitable way.

1. A method for operating a light emitting diode (LED, 1), which method comprises measuring the ambient temperature surrounding said LED (1), and controlling a current flowing through said LED (1) depending on the measured temperature.

2. A method according to claim 1, wherein said current through said LED (1) is controlled in a way that the higher the measured temperature, the lower is the average current through the LED (1).

3. A method according to claim 1, wherein said current flowing through said LED (1) is a continuous current, and wherein said current is varied analogously depending on the measured temperature.

4. A method according to claim 1, wherein said current flowing through said LED (1) is a pulsed current, which pulsed current is controlled by controlling the duty ratio of the pulsing depending on the measured temperature.

5. A method according to claim 1, wherein said current is controlled on the cathode side of said LED (1).

6. A method according to claim 1, wherein said current is controlled on the anode side of said LED (1).

7. A device comprising at least one light emitting diode (LED,1), a temperature sensing element (2) for measuring the ambient temperature surrounding the at least one LED, and controlling means (3) for controlling a current flowing through said at least one LED (1) depending on the measured temperature.

8. A device according to claim 7, further comprising a pulsing element (5) for pulsing a current flowing through said at least one LED (1), which pulsing element is controlled by said controlling means (3) depending on the measured temperature.

9. A device according to claim 7, wherein said current flowing through said at least one LED is controlled on the side of the cathode of the at least one LED depending on the measured temperature.

10. A device according to claim 9, comprising switching means for pulsing the current flowing through said at least one LED, wherein said switching means connect the cathode of said at least one LED to ground for turning said at least one LED on and connect said cathode of said at least one LED to a predetermined voltage for turning said at least one LED off, and wherein said switching means are controlled by said controlling means depending on the measured temperature.

11. A device according to claim 7, wherein said current flowing through said at least one LED (1) is controlled on the side of the anode of said at least one LED (1) depending on the measured temperature.

12. A device according to claim 11, comprising an LED driver (4) for supplying a current to said at least one LED (1), which LED driver (4) includes a pulsing element (5) for pulsing said current supplied to said at least one LED (1), which pulsing element (5) is controlled by said controlling means (3) depending on the measured temperature.

13. A device according to claim 11, comprising an engine IC, which engine IC includes a pulsing element for pulsing a current supplied to said at least one LED, which pulsing element is controlled by said controlling means depending on the measured temperature.

14. A device according to claim 7, wherein said controlling means is an engine IC (3), which engine IC has access to the measurement results of the temperature sensing element (2).

15. A device according to claim 14, wherein said engine IC comprises said temperature sensing element.

16. A device according to claim 7, wherein said controlling means is an LED driver, which LED driver has access to the measurement results of the temperature sensing element.

17. A device according to claim 16, wherein said LED driver comprises said temperature-sensing element.

18. A device according to claim 7, wherein said at least one LED (1) is part of a display or of a keypad lighting of a user interface hardware.
